(19) United States
(12) Patent Application Publication
(10) Pub. No.: US 2026/0244869 A1
(43) Pub. Date: Aug. 20, 2026

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventor: Mana IHORI, Musashino-shi, Tokyo (JP)

(73) Assignee: NTT, Inc., Tokyo (JP)

(21) Appl. No.: 19/156,017

(22) PCT Filed: Feb. 14, 2023
(86) PCT No.: PCT/JP2023/005013

§ 371 Date: Aug. 13, 2025

(51) Int. Cl. G06F 40/30; G06F 40/58; G06N 3/045

(52) U.S. Cl. CPC G06F 40/30; G06F 40/58; G06N 3/045

(57) ABSTRACT

A learning device includes a memory and processing circuitry configured to accept input of text, a template of a feedback comment for the text, and a mask template in which zero or one or more words of the template are masked, and generate a first trained model that outputs the mask template in a case where the text and the template are input using the text, the template, and the mask template whose input has been accepted as first training data.

### TECHNICAL FIELD

The present invention relates to a learning device, a learning method, and a learning program.

### BACKGROUND ART

Among natural language processing techniques, there is a sequence conversion technique, as a text generation technique, of using a neural network to generate target text which is text obtained by performing predetermined conversion on source text from source text which is text to be processed on the basis of text of a specified template.

Examples of the above-described technique include a task of performing sequence conversion such as neural machine translation in which source text consisting of a sequence of words (word sequence) including one or more words is input into a trained model such as a neural network, and converted into target text consisting of a word sequence in another language. In such a task, a sequence conversion model using a neural network such as an encoder-decoder model (neural sequence conversion model) is usually used.

Among tasks of using a neural sequence conversion model (sequence conversion task), a task of generating a feedback comment (comment) for a sentence with grammatical errors is known. In this task, in a case where a sentence containing a grammatical error is input as source text, a comment to help a language learner with the grammatical error is output as target text. For example, in this task, in a case where the source text “He agrees the opinion,” is input as source text, “‘Agree’ is an intransitive verb, so an appropriate preposition is needed. Let's look up ‘agree’ in the dictionary,” or the like is output as target text.

In such a task with a higher degree of freedom for generating a comment for the source text, external knowledge related to what is written in the source text (here, the knowledge that “agree” is an intransitive verb, and an intransitive verb requires a preposition) is required, which makes it more difficult to generate the target text from zero as in the case with normal sequence conversion tasks.

Consequently, a method of inputting already existing target text into a neural sequence conversion model and newly generating target text to rewrite it has been proposed. For example, there is a method of substantially rewriting “adapt” to “agree” by inputting “He agrees the opinion,” and “‘Adapt’ is an intransitive verb, so it needs an appropriate preposition. Let's look up ‘adapt’ in the dictionary,” and outputting “‘Agree’ is an intransitive verb, so an appropriate preposition is needed. Let's look up ‘agree’ in the dictionary,” (see, for example, NPL 1).

In this way, complex generation requiring external knowledge or the like can be performed more easily by using already existing text as a template for a comment on the source text and generating new text to rewrite the template. This method is useful not only for a task of generating a comment, but also for a task in which new target text can be obtained by changing the template, such as generating an opinion about a certain sentence.

### CITATION LIST

### Non Patent Literature

[NPL 1] Tatsunori B Hashimoto, Kelvin Guu, Yonatan Oren, and Percy Liang. A Retrieve-and-Edit Framework for Predicting Structured Outputs. In Proc. NeurIPS, pp. 10052-10062, 2018.

### SUMMARY OF INVENTION

### Technical Problem

However, the above-described method of using a template and rewriting the template is prone to excessive changes to the template. For example, this method aims to convert only a part of the template, but problems such as rewriting the whole text of the template often occur. This is because the performance of this method varies greatly depending on the choice of a template used to train a neural network.

In addition, if the template and the target text are almost the same, it is sufficient to learn to rewrite only a part of it. However, in a case where the template and the target text are significantly different, a trained model such as a neural sequence conversion model will learn to rewrite many words. As described above, in the related art, since the range and amount of a template to be rewritten vary depending on the template and it is difficult to prepare only templates similar to the target text, it is difficult to perform appropriate learning or prediction on the range and amount to be rewritten, resulting in a tendency to cause occurrence of excessive changes to the template.

### Solution to Problem

In order to solve the above problem and achieve the object, a learning device includes: a first input acceptance unit configured to accept input of text, a template of a feedback comment for the text, and a mask template in which zero or one or more words of the template are masked; and a first trained model generation unit configured to generate a first trained model that outputs the mask template in a case where the text and the template are input using the text, the template, and the mask template whose input has been accepted by the first input acceptance unit as first training data.

### Advantageous Effects of Invention

According to the present invention, excessive changes to the template can be made less likely.

### BRIEF DESCRIPTION OF DRAWINGS

FIG. 1 is a diagram illustrating an example of a configuration of a learning device.

FIG. 2 is a diagram illustrating an overview of a first generation unit and a second generation unit.

FIG. 3 is a diagram illustrating an example of a configuration of the first generation unit.

FIG. 4 is a diagram illustrating an example of a configuration of the second generation unit.

FIG. 5 is a flowchart illustrating an example of a flow of processing performed by the learning device.

FIG. 6 is a flowchart illustrating an example of a flow of a feedback comment generation process performed by the learning device.

FIG. 7 is a diagram illustrating an example of a computer that executes a learning program.

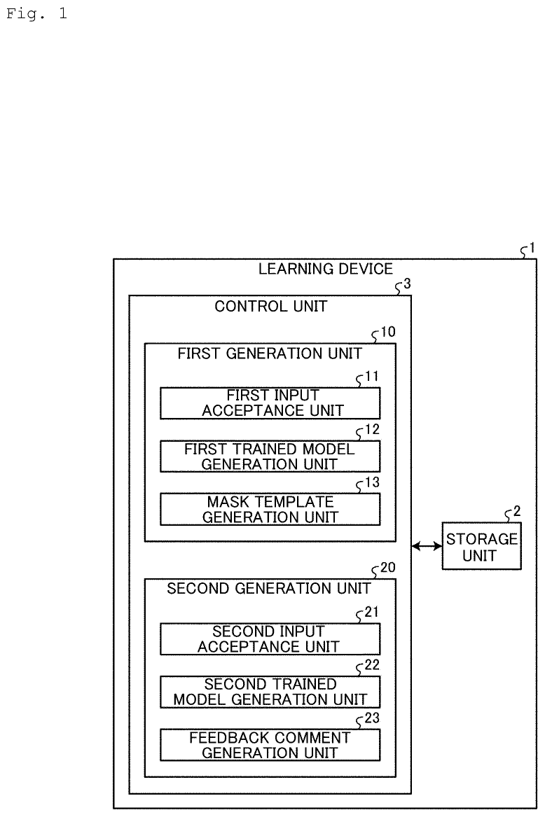

Hereinafter, embodiments of the present invention will be described in detail with reference to the accompanying drawings. However, the present invention is not limited to the following embodiments. In addition, in description of the drawings, the same portions are denoted by the same reference numerals, and repeated description will be omitted.

[1. Configuration example of learning device] A learning device 1 according to an embodiment will be described with reference to FIG. 1. FIG. 1 is a diagram illustrating a configuration example of the learning device 1 according to the embodiment. In a case where text and a template of a feedback comment for the text are input, the learning device 1 generates a first trained model that outputs a mask template in which zero or one or more words of the template are masked.

Here, examples of the text include source text and the like, and examples of the feedback comment include target text and the like. An example of the mask template is a template in which a portion to be changed is specified by a mask, such as a template in which a portion to be changed in the template is replaced with a special token or the like called a mask token. For the mask template, in a case where the number of masked words in the template is 0, that is, a case where no words in the template have been masked, the mask template is the template itself. In this way, the mask template referred to here also includes one in which none of the words are masked. A mask token is a special token used in a masked language model which is a neural language model that predicts only words replaced with mask tokens in text such as, for example, bidirectional encoder representations from transformers (BERT). For the details of the mask token, see the following Reference Literature 1.
Reference Literature 1: Jacob Devlin, Ming-Wei Chang, Kenton Lee, and Kristina Toutanova.
BERT: Pre-training of Deep Bidirectional Transformers for Language Understanding. arXiv: 1810.04805, 2018.

For example, the learning device 1 generates a first trained model that outputs a mask template in which words are replaced with mask tokens by masking only the words in the portions to be changed in the template. As an example, in a case where the text “He agrees the opinion,” and the template “‘Agree’ is an intransitive verb, so an appropriate preposition is needed. Let's look up ‘agree’ in the dictionary,” are input, the learning device 1 generates a first trained model that outputs a mask template “[MASK] is an intransitive verb, so an appropriate preposition is needed. Let's look up [MASK] in the dictionary.”

Examples of the first trained model include a sequence labeling model (neural sequence labeling model), a neural sequence conversion model, and the like in which a neural network is used, and any model which is at least one of these models can be used. Examples of the neural sequence labeling model include a model that uses a bidirectional long short term memory (LSTM), and the like. Examples of the neural sequence conversion model include a model that uses an attention-based encoder-decoder model, a transformer, and the like. For the details of these models, see the following Reference Literatures 2 to 4.
Reference Literature 2: Ji Ma, Kuzman Ganchev, and David Weiss.
State-of-the-art Chinese Word Segmentation with Bi-LSTMs. In Proc. EMNLP, pp. 4902-4908, 2018.
Reference Literature 3: Minh-Thang Luong, Hieu Pham, and Christopher D. Manning.
Effective Approaches to Attention-based Neural Machine Translation. In Proc. EMNLP, pp. 1412-1421, 2015.
Reference Literature 4: A. Vaswani, N. Shazeer, N. Parmar, J. Uszkoreit, L. Jones, A. N. Gomez, L. Kaiser, and I.
Polosukhin. Attention Is All You Need. In Proc. NIPS, pp. 5998-6008, 2017.

As described above, the learning device 1 is applied to a case where a task of generating a feedback comment is performed on text containing grammatical errors from translating Japanese text into English. However, the learning device 1 can also be applied to tasks other than this task, such as a task of generating a feedback comment for text in another language such as Japanese, and a task of generating a feedback comment for articles on a website. In this case, the learning device 1 can perform another task in a similar manner to the above-described example, except that text, a template, a mask template, and a feedback comment different from those in the above-described example are used.

In order to perform such processing, the learning device 1 first generates a first trained model that outputs a mask template in a case where text and a template of a feedback comment for the text are input. Next, the learning device 1 generates a second trained model that outputs a feedback comment in a case where text and a mask template are input. Examples of the second trained model include a neural sequence labeling model, a neural sequence conversion model, and the like, and there is no particular limitation thereto insofar as these models are used. As shown in FIG. 1, the learning device 1 includes a storage unit 2 and a control unit 3.

The storage unit 2 stores an operating system (OS) and various programs executed by the learning device 1, and various types of data such as text, a template, a mask template, a feedback comment, a first trained model, and a second trained model. Examples of the storage unit 2 include storage devices such as a hard disk drive (HDD), a solid state drive (SSD), and an optical disc. The storage unit 2 may be a semiconductor memory in which data can be rewritten, such as a random access memory (RAM), a flash memory, or a non-volatile static random access memory (NVSRAM). The storage unit 2 stores an operating system (OS) and various programs executed by the learning device 1.

The control unit 3 controls the entirety of the learning device 1. The control unit 3 is, for example, an electronic circuit such as a central processing unit (CPU), a micro processing unit (MPU), or a graphics processing unit (GPU), as well as an integrated circuit such as an application specific integrated circuit (ASIC) or a field programmable gate array (FPGA). In addition, the control unit 3 has an internal memory for storing control data and programs that define various processing procedures, and executes each process using the internal memory. In addition, the control unit 3 functions as various processing units by operating various programs. As shown in FIG. 1, the control unit 3 includes a first generation unit 10 and a second generation unit 20.

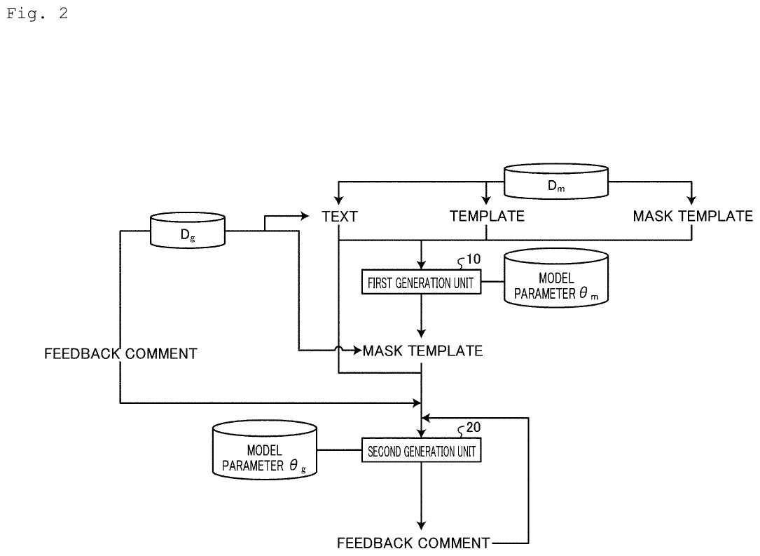

Before the configuration examples of the first generation unit 10 and the second generation unit 20 are described, an overview of the first generation unit 10 and the second generation unit 20 will be described below with reference to FIG. 2. FIG. 2 is a diagram illustrating an overview of the first generation unit 10 and the second generation unit 20. In addition, the first generation unit 10 uses the text, template, and mask template included in a set Dₘ or a set D_{g} which will be described later as first training data to train the first trained model until a model parameter ⊙ₘ is optimized. In addition, the first generation unit 10 generates a mask template on the basis of output information which is output from the first trained model by probability calculation according to the optimized model parameter ⊙ₘ of the first trained model. Next, the second generation unit 20 uses the text, the mask template, and the feedback comment included in a set Dₘ or a set D_{g} which will be described later as second training data to train the second trained model until a model parameter ⊙_{g} is optimized. In addition, the second generation unit 20 generates a feedback comment on the basis of output information which is output from the second trained model by probability calculation according to the optimized model parameter ⊙_{g} of the second trained model. The second generation unit 20 recursively performs the above-described process by training the second trained model using the feedback comment output from the second trained model as the second training data.

[1-1. Configuration example of first generation unit] The first generation unit 10 generates a first trained model and a mask template. As shown in FIG. 1, the first generation unit 10 includes a first input acceptance unit 11, a first trained model generation unit 12, and a mask template generation unit 13.

[1-1-1. Configuration example of first input acceptance unit] The first input acceptance unit 11 accepts input of text, a template of a feedback comment for the text, and a mask template in which zero or one or more words of the template are masked. The first input acceptance unit 11 may accept these inputs from outside the learning device 1, or may accept inputs selected from the data of the storage unit 2.

[1-1-2. Configuration example of first trained model generation unit] The first trained model generation unit 12 generates a first trained model using the text, template, and mask template whose input has been accepted by the first input acceptance unit 11 as first training data. For example, the first trained model generation unit 12 generates the first trained model by performing machine learning on the first trained model using the first training data until the model parameters of the first trained model are optimized.

The first trained model generation unit 12 may use any text as the first training data. The first trained model generation unit 12 may use any mask template as the first training data insofar as unmasked words are all included in the words of the feedback comments. That is, the first trained model generation unit 12 may generate the first trained model using the mask template, excluding words in the masked portion and including only the words of the feedback comment, as the first training data. For example, the first trained model generation unit 12 may use a mask template in which words to be masked are selected by manual labeling as the first training data. In addition, the first trained model generation unit 12 may use a mask template in which words to be masked are selected as the first training data on the basis of a rule base that uses information on parts of speech such as verbs or nouns to mask only words of specific parts of speech.

The first trained model generation unit 12 may generate the first trained model using the first training data in which at least one of the text and the template includes at least one of first semantic information indicating the meaning of one or more words and second semantic information indicating the meaning of the entire sentence.

Hereinafter, the first trained model generation unit 12 will be described in detail using equations. The first trained model generation unit 12 inputs a set Dₘ of groups of a sequence of words (word sequence) X={x₁, . . . , xₙ} in text, a word sequence Y={y₁, . . . , yₙ} in a template, and a sequence of mask labels (mask label sequence) L={l₁, . . . , lₙ} that mask the words in the template, as the first training data, into the first trained model, and performs machine learning on the first trained model until the model parameter ⊙ₘ is optimized.

Here, in a case where the word sequence is constituted by English words, the first trained model generation unit 12 may, for example, regard one unit separated by a space as one word. In a case where the word sequence is constituted by Japanese words, the first trained model generation unit 12 may, for example, regard one unit automatically divided by morphological analysis or one unit separated into character units as one word.

The optimized model parameter ⊙ₘ follows Equation (1) below. The optimization of the model parameter ⊙ₘ performed by the first trained model generation unit 12 need only be performed using a general optimization method in neural network training. In addition, the first generation unit 10 is assumed to use ⊙ₘ shown in the following Equation (1) as the optimized model parameter ⊙ₘ.

$$\begin{matrix}[ Math . 1 ] & \\ {Θ}_{m} = arg {max}_{{Θ}_{m}} {\prod }_{( X , Y , L ) ϵ {D}_{m}} P ( L \vert X , Y , {Θ}_{m} ) & ( 1 )\end{matrix}$$

In an example in which the above-mentioned equation is used, the first trained model generation unit 12 generates the first trained model that does not directly output a mask template but outputs information relating to a mask level indicating which word in the mask template, starting from the first word, is masked by the mask label. However, the first trained model generation unit 12 may generate the first trained model that outputs a mask template instead of a mask label sequence. In this case, the first trained model generation unit 12 may use the mask template as the first training data instead of the mask label sequence. In this case, the first trained model generation unit 12 can also generate the first trained model in the same way as in the above-described example. In addition, in a case where the first trained model generation unit 12 uses the mask template as the first training data instead of the mask label sequence, the mask template generation unit 13 to be described later can generate the mask template by using the output information from the first trained model as it is.

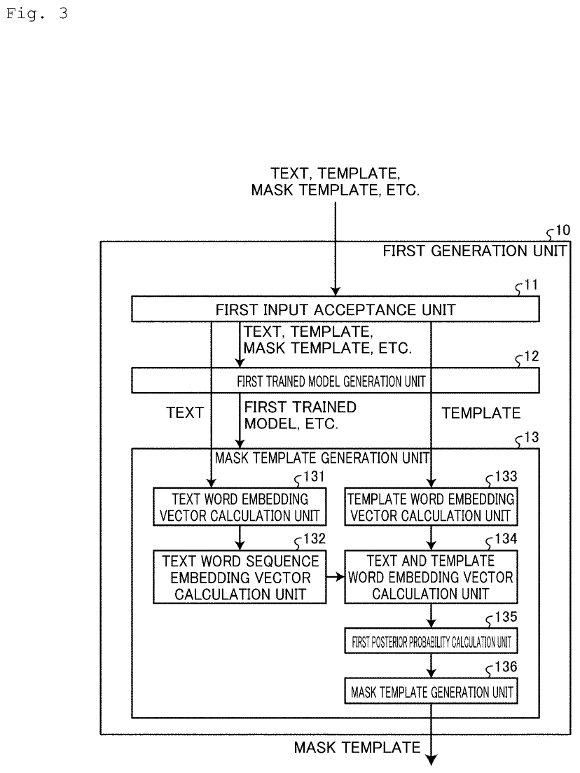

Hereinafter, an example of the first trained model generation unit 12 will be described in more detail with reference to FIG. 3. FIG. 3 is a diagram illustrating an example of a configuration of the first generation unit 10. In the above-described example, a case in which the first trained model generation unit 12 generates one first trained model using a set of pieces of first training data has been described. However, as shown in FIG. 3, in a case where the mask template generation unit 13 has a plurality of members, the first trained model generation unit 12 may generate a plurality of trained models corresponding to each of a plurality of members. In this case, the model parameter ⊙ₘ is expressed as ⊙ₘ={⊙ₕ, ⊙ᵤ, ⊙_{w}, ⊙ₚ}.

For example, the first trained model generation unit 12 may generate a trained model for text word embedding vector calculation which is used by a text word embedding vector calculation unit 131 to calculate a text word embedding vector. Here, the text word embedding vector is a vector in which the first semantic information indicating the meaning of one or more words in text is embedded. This first semantic information is used to determine the portion to be masked for the template which is the portion of the word in the template corresponding to the word of the text. The number of dimensions of the text word embedding vector and a method of determining the number of dimensions are not particularly limited, but the number of dimensions may be 512 or the like, and the method of determining the number of dimensions may be a method of manually determining the number of dimensions. In this way, as the number of dimensions becomes larger, the text word embedding vector contains more information.

As an example, the first trained model generation unit 12 generates a trained model for text word embedding vector calculation using text and a text word embedding vector in which the first semantic information is embedded in the text as training data for text word embedding vector calculation. The first trained model generation unit 12 generates a trained model for text word embedding vector calculation by performing machine learning on the trained model for text word embedding vector calculation using the training data for text word embedding vector calculation until the model parameters of the trained model for text word embedding vector calculation are optimized.

The first trained model generation unit 12 may generate a trained model for text word sequence embedding vector calculation used by a text word sequence embedding vector calculation unit 132 to calculate a text word sequence embedding vector. Here, the text word sequence embedding vector is a vector including semantic information relating to a word sequence in which the first semantic information indicating the meaning of each word of the text is aggregated, that is, second semantic information indicating the meaning of the entire text. This second semantic information is used to determine the portion to be labeled for the word sequence of the next template. The number of dimensions of the text word sequence embedding vector and a method of determining the number of dimensions are not particularly limited, but, for example, the number of dimensions may be 512 or the like, and the method of determining the number of dimensions may be a method of manually determining the number of dimensions. In this way, as the number of dimensions becomes larger, the text word sequence embedding vector contains more information.

As an example, the first trained model generation unit 12 generates a trained model for text word sequence embedding vector calculation using the text word embedding vector and the text word sequence embedding vector as training data for text word sequence embedding vector calculation. The first trained model generation unit 12 generates a trained model for text word sequence embedding vector calculation by performing machine learning on the trained model for text word sequence embedding vector calculation using the training data for text word sequence embedding vector calculation until the model parameters of the trained model for text word sequence embedding vector calculation are optimized.

The first trained model generation unit 12 may generate a trained model for template word embedding vector calculation used by a template word embedding vector calculation unit 133 to calculate a template word embedding vector. Here, the template word embedding vector is a vector in which the first semantic information indicating the meaning of one or more words in a template is embedded. This first semantic information is used to determine the portion to be masked for the template which is the portion of the word in the template corresponding to the word of the text. The number of dimensions of the template word embedding vector may be 512 or the like, and the method of determining the number of dimensions may be a method of manually determining the number of dimensions. In this way, as the number of dimensions becomes larger, the template word embedding vector contains more information.

As an example, the first trained model generation unit 12 generates a trained model for template word embedding vector calculation using a template and a template word embedding vector in which the first semantic information is embedded in the template as training data for template word embedding vector calculation. The first trained model generation unit 12 generates a trained model for template word embedding vector calculation by performing machine learning on the trained model for template word embedding vector calculation using the training data for template word embedding vector calculation until the model parameters of the trained model for template word embedding vector calculation are optimized.

The first trained model generation unit 12 may generate a trained model for text and template word embedding vector calculation used by a text and template word embedding vector calculation unit 134 to calculate a text and template embedding vector. Here, the text and template embedding vector is a vector in which information on the text word sequence embedding vector is embedded in the template word embedding vector. As a method of embedding information on the text word sequence embedding vector in the template word embedding vector, any function may be used insofar as it is a method using a conversion function of converting these two vectors into one vector. Examples of the method using a function of converting these two vectors into one vector include a method using a function of adding these two vectors together, a method of connecting two vectors, and the like. In these methods, the number of dimensions of the template word embedding vector and the number of dimensions of the text word sequence embedding vector need to be the same as each other.

As an example, the first trained model generation unit 12 generates a trained model for text and template word embedding vector calculation using the template word embedding vector, the text word sequence embedding vector, and the text and template embedding vector as training data for text and template word embedding vector calculation. The first trained model generation unit 12 generates a trained model for text and template word embedding vector calculation by performing machine learning on the trained model for text and template word embedding vector calculation using the training data for text and template word embedding vector calculation until the model parameters of the trained model for text and template word embedding vector calculation are optimized.

The first trained model generation unit 12 may generate a trained model for posterior probability calculation used by a first posterior probability calculation unit 135 to calculate posterior probability. Here, the first posterior probability is a posterior probability in which a mask label is masked for a word in the template. Examples of the first posterior probability include those in which each mask label can be expressed as a vector, the probability distribution of the posterior probability can be expressed by vector conversion, and the like.

As an example, the first trained model generation unit 12 generates a first trained model for posterior probability calculation using the text and template word embedding vector and the first posterior probability as first training data for posterior probability calculation. The first trained model generation unit 12 generates a first trained model for posterior probability calculation by performing machine learning on the first trained model for posterior probability calculation using the first training data for posterior probability calculation until the model parameters of the first trained model for posterior probability calculation are optimized.

The first trained model generation unit 12 may generate a trained model for mask template generation used by the mask template generation unit 136 to generate a mask template. As an example, the first trained model generation unit 12 generates a trained model for mask template generation using the first posterior probability and the mask template as training data for mask template generation. The first trained model generation unit 12 generates a trained model for mask template generation by performing machine learning on the trained model for mask template generation using the training data for mask template generation until the model parameters of the trained model for mask template generation are optimized.

[1-1-3. Configuration example of mask template generation unit] The mask template generation unit 13 uses the first trained model generated by the first trained model generation unit 12 to generate a mask template on the basis of the text and template whose input has been accepted by the first input acceptance unit 11. In this case, the mask template generation unit 13 inputs the text and template into the first trained model, and generates a mask template on the basis of the output information which is output from the first trained model by probability calculation according to the model parameters of the first trained model. For example, on the basis of the output information indicating which word in the mask template, starting from the first word, is masked by the mask label, the mask template generation unit 13 generates a mask template in which the portion equivalent to this number is masked.

The mask template generation unit 13 may use a comment or a template selected from the comments or templates used in the first training data. The mask template generation unit 13 may use a template selected from the feedback comments used for the second training data to be generated by a second trained model generation unit 22 to be described later. The mask template generation unit 13 may use a comment or a template selected from the storage unit 2 that functions as a data pool. Any method may be used insofar as the method of selecting a template is a method of extracting one template. The method of selecting a template may be a method of selecting the highest similarity between the template and the feedback comment used in the second training data, or may be a method of random selection.

Hereinafter, an example of the mask template generation unit 13 will be described in detail using equations. The mask template generation unit 13 inputs the text and template into the first trained model, and generates a mask template on the basis of the output information which is output from the first trained model by probability calculation according to the model parameters of the first trained model.

For example, the mask template generation unit 13 generates a word sequence Y′={y₁′, . . . , yₙ′} of a mask template by masking a mask label sequence L for masking the nth word of the word sequence Y of the template, output from the first trained model, with the nth word of the template. In this case, the mask template generation unit 13 uses the first trained model to obtain a first posterior probability P(lₙ|X, Y, ⊙ₘ) of the mask label to be masked for the nth word of the template, and determines a mask label ln′ to be masked for the nth word by a maximum likelihood criterion according to the following Equation (2). A detailed description of the first posterior probability P(lₙ|X, Y, ⊙ₘ) of the mask label will be described later.

$$\begin{matrix}[ Math . 2 ] & \\ {l}_{n}^{′} = arg {max}_{{l}_{n}} P ( {l}_{n} \vert X , Y , {Θ}_{m} ) & ( 2 )\end{matrix}$$

The mask template generation unit 13 generates a mask label sequence L corresponding to the word sequence Y of the template by performing the above-described process on all word sequences included in the template. Here, lₙ is an element of a set constituted by 0 and 1. The mask template generation unit 13 determines the value of n equivalent to the portion of the word to be masked by the mask label, with 1 for words which are not included in the word sequence of the feedback comment for the text and 0 for the rest among the words of the template.

Hereinafter, an example of the mask template generation unit 13 will be described in more detail with reference to FIG. 3. As an example, the mask template generation unit 13 includes the text word embedding vector calculation unit 131, the text word sequence embedding vector calculation unit 132, the template word embedding vector calculation unit 133, the text and template word embedding vector calculation unit 134, the first posterior probability calculation unit 135, and the mask template generation unit 136.

The text word embedding vector calculation unit 131 calculates a text word embedding vector using the trained model for text word embedding vector calculation generated by the first trained model generation unit 12. For example, the text word embedding vector calculation unit 131 inputs a word sequence X={x₁, . . . , xₘ} of the text into the trained model for text word embedding vector calculation, and calculates output information which is output from the trained model for text word embedding vector calculation as a text word embedding vector hm. As an example, the text word embedding vector calculation unit 131 calculates the converted word sequence X of the text as the text word embedding vector hm using a conversion function based on the optimized model parameter @ of the trained model for text word embedding vector calculation.

In this case, the conversion function can any function capable of converting a variable-length symbol string into a variable-length vector such as, for example, a function that constitutes a word frequency vector in text, a recurrent neural network, a bidirectional recurrent neural network, and those in which a self-attention mechanism such as that disclosed in Reference Literature 3 above is used.

The text word sequence embedding vector calculation unit 132 calculates the text word sequence embedding vector using the trained model for text word sequence embedding vector calculation generated by the first trained model generation unit 12. For example, the text word sequence embedding vector calculation unit 132 inputs the word sequence H={h₁, . . . , hₘ} of the text word embedding vector calculated by the text word embedding vector calculation unit 131 into the trained model for text word sequence embedding vector calculation, and calculates the output information which is output from the trained model for text word sequence embedding vector calculation as a text word sequence embedding vector uₘ. As an example, the text word sequence embedding vector calculation unit 132 calculates the converted word sequence H of the text word embedding vector as the text word sequence embedding vector uₘ using a conversion function based on the optimized model parameter Qu of the trained model for text word sequence embedding vector calculation.

In this case, the conversion function can be any function of converting a variable-length vector sequence into a single vector such as, for example, a recurrent neural network and a function of averaging each vector in the word sequence of the text word sequence embedding vector. In a case where each vector is averaged, the number of dimensions of the text word sequence embedding vector depends on the number of dimensions of each text word sequence embedding vector.

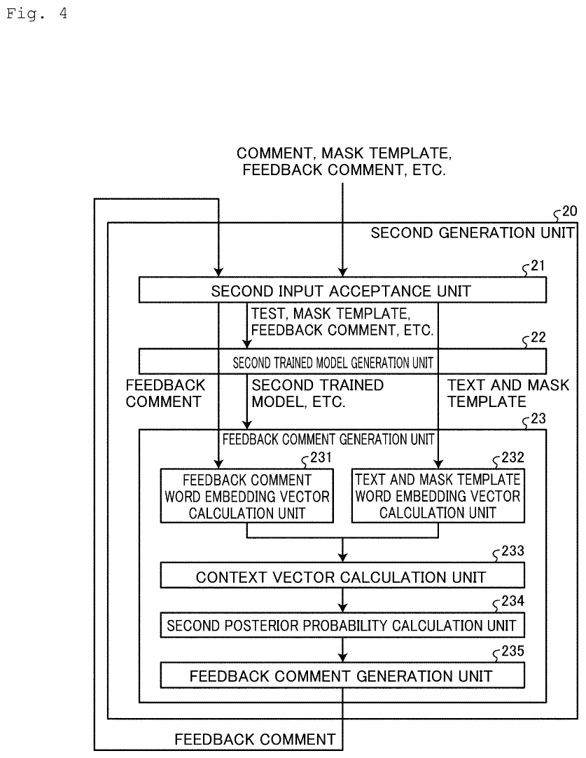

In the example shown in FIG. 3 and FIG. 4 to be described later, only the text word sequence embedding vector calculation unit 132 calculates the word sequence embedding vector including the second semantic information from the word embedding vector including the first semantic information. However, if the meaning of the entire sentence is unknown or the meaning of the entire sentence is a word embedding vector other than the mask template word embedding vector to be changed, each member can calculate the word sequence embedding vector from the word embedding vector. For example, the mask template generation unit 13 may further include a template word sequence embedding vector calculation unit and a text and template word sequence embedding vector calculation unit. The template word sequence embedding vector calculation unit may calculate the template word sequence embedding vector, and the text and template word embedding vector calculation unit 134 may calculate the text and template word sequence embedding vector.

The template word embedding vector calculation unit 133 calculates the template word embedding vector using the trained model for template word embedding vector calculation generated by the first trained model generation unit 12. For example, the template word embedding vector calculation unit 133 inputs the word sequence Y={y₁, . . . , yₙ} of the template into the trained model for template word embedding vector calculation, and calculates the output information which is output from the trained model for template word embedding vector calculation as a template word embedding vector wₙ. As an example, the template word embedding vector calculation unit 133 calculates the converted word sequence Y of the template as the template word embedding vector wₙ using a conversion function based on the optimized model parameter of the trained model for template word embedding vector calculation. In this case, examples of the conversion function include those similar to the conversion function used in the calculation of the text word embedding vector performed by the text word embedding vector calculation unit 131 described above.

The text and template word embedding vector calculation unit 134 calculates the text and template word embedding vector using the trained model for text and template word embedding vector calculation generated by the first trained model generation unit 12. For example, the text and template word embedding vector calculation unit 134 inputs the text word sequence embedding vector uₘ calculated by the text word sequence embedding vector calculation unit 132 and the template word embedding vector wₙ calculated by the template word embedding vector calculation unit 133 into the trained model for text and template word embedding vector calculation. Next, the text and template word embedding vector calculation unit 134 calculates the output information which is output from the trained model for text and template word embedding vector calculation as text and template word embedding vector vₙ corresponding to the nth word of the template. As an example, the text and template word embedding vector calculation unit 134 calculates the converted text word sequence embedding vector uₘ and template word embedding vector wₙ as the text and template word embedding vector vₙ corresponding to the nth word of the template using a conversion function based on the optimized model parameter of the trained model for text and template word embedding vector calculation.

In this case, examples of the conversion function include those similar to the conversion function used in the generation of the trained model for text and template word embedding vector calculation performed by the first trained model generation unit 12 described above.

The first posterior probability calculation unit 135 calculates the first posterior probability using the first trained model for posterior probability calculation generated by the first trained model generation unit 12. For example, the first posterior probability calculation unit 135 inputs the text and template word embedding vector vₙ calculated by the text and template word embedding vector calculation unit 134, which corresponds to the nth word of the template, into the first trained model for posterior probability calculation, and calculates the output information which is output from the first trained model for posterior probability calculation as the first posterior probability P(ln|X, Y, ⊙ₘ) in which a mask label is assigned to the nth word of the template. As an example, the first posterior probability calculation unit 135 calculates the converted text and template word embedding vector vₙ corresponding to the nth word of the template as the first posterior probability P(lₙ|X, Y, ⊙ₘ) in which a mask label is assigned to the nth word of the template using a conversion function based on the optimized model parameter ⊙ₚ of the first trained model for posterior probability calculation.

In this case, any conversion function can be used insofar as the conversion function is a function of converting a vector into a posterior probability distribution. Examples of the conversion function include a function of performing conversion using a softmax function, a function capable of converting the sum of the elements of an output vector equivalent to the posterior probability distribution into 1.0, and the like.

The mask template generation unit 136 generates a mask template using the trained model for mask template generation generated by the first trained model generation unit 12. The mask template generation unit 136 inputs the word sequence Y of the template and a first posterior probability P(l₁|X, Y, ⊙ₘ), . . . , P(lₙ|X, Y, ⊙ₘ) in which mask labels are assigned to the word sequences of the first to nth templates calculated by the first posterior probability calculation unit 135 into the trained model for mask template generation, and calculates the output information which is output from the trained model for mask template generation as the word sequence Y′ of the mask template.

In this case, the mask template generation unit 136 selects the maximum first posterior probability P (l₁|X, Y, ⊙ₘ), . . . , P(lₙ|X, Y, ⊙ₘ) in which a mask label is assigned to the word sequence Y={y₁, . . . , yₙ} of the first to nth templates. As an example, the mask template generation unit 136 selects the first posterior probability P(lₙ|X, Y, ⊙ₘ) corresponding to the word yₙ of the nth template. Next, the mask template generation unit 136 replaces a word equivalent to the nth word yₙ of the template with a mask token by assigning a mask label to the word.

Here, in a case where consecutive words are successively replaced with mask tokens, the mask template generation unit 136 replaces these mask tokens with one mask token. In a case where none of the words in the template are masked, the mask template generation unit 136 outputs the word sequence of the template, as it is, as the word sequence of the feedback comment for the text.

In addition, the mask template generation unit 136 may replace consecutive words to be masked with one mask token using span masking which enables a feedback comment generation unit 23 to be described later to predict one or more words from one mask token. The masked words are replaced with mask tokens, but the number of masked words and the number of words to be predicted are not necessarily equal to each other, and by the mask template generation unit 136 using span masking, the feedback comment generation unit 23 can predict a different number of words than the number of masked words. For the details of span masking, see Reference Literature 5 below.
Reference Literature 5: Colin Raffel, Noam Shazeer, Adam Roberts, Katherine Lee, Sharan Narang, Michael Matena, Yanqi Zhou, Wei Li, and Peter J. Liu.
Exploring the Limits of Transfer Learning with a Unified Text-to-Text Transformer. Journal of Machine Learning Research, pp. 1-67, 2020.

[1-2. Configuration example of second generation unit] The second generation unit 20 generates a second trained model and a feedback comment. As shown in FIG. 1, the second generation unit 20 includes a second input acceptance unit 21, the second trained model generation unit 22, and the feedback comment generation unit 23.

### [1-2-1. Configuration Example of Second Input Acceptance Unit]

The second input acceptance unit 21 accepts input of text, a mask template, and a feedback comment in which the masked portion of the mask template has been changed. The second input acceptance unit 21 may accept these inputs from outside the learning device 1, or may accept inputs selected from those stored in the storage unit 2. In addition, the second input acceptance unit 21 may accept input of a feedback comment output from the second trained model, that is, a feedback comment generated by the feedback comment generation unit 23.

[1-2-2. Configuration example of second trained model generation unit] The second trained model generation unit 22 generates the second trained model using text, a mask template, and a feedback comment whose input has been accepted by the second input acceptance unit 21 as the second training data. For example, the second trained model generation unit 22 generates the second trained model by performing machine learning on the second trained model using the second training data until the model parameters of the second trained model are optimized.

The second trained model generation unit 22 may use any text as the second training data. The second trained model generation unit 22 may use any mask template as the second training data insofar as unmasked words are all included in the words of the feedback comments. That is, the second trained model generation unit 22 may generate the second trained model using a mask template, including only the words of the feedback comment and excluding words in the masked portion, as the second training data. For example, the second trained model generation unit 22 may use a mask template in which words to be masked are selected by manual labeling as the first training data. In addition, the second trained model generation unit 22 may use a mask template in which words to be masked are selected as the second training data on the basis of a rule base that uses information on parts of speech such as verbs or nouns to mask only words of specific parts of speech.

The second trained model generation unit 22 may recursively train the second trained model using the feedback comment output from the second trained model (the feedback comment generated by the feedback comment generation unit 23) as the second training data. The second trained model generation unit 22 may generate the second trained model using the second training data in which the first semantic information is included in at least one of the text, the mask template, and the feedback comment. The second trained model generation unit 22 may generate the second trained model using the second training data in which the second semantic information is included in at least one of the text and the feedback comment. The second trained model generation unit 22 may generate the second trained model using the second training data in which the feedback comment contains context information indicating which word is changed in order from the first word of the feedback comment, according to the text and the mask template. The details of these will be described later.

Hereinafter, an example of the second trained model generation unit 22 will be described in detail using equations. The second trained model generation unit 22 inputs a set D_{g} of groups of a word sequence X={x₁, . . . , xₙ} of the text, a word sequence Y′={y₁′, . . . , yₙ′} of the mask template, a word sequence Y″={y₁″, . . . , yₙ₋₁″} of the first to (n−1)th feedback comments already generated by the feedback comment generation unit 235, and the nth word yₙ″ of the feedback comment for the text, as the second training data, into the second trained model, and performs machine learning on the second trained model until the model parameter ⊙_{g} is optimized. The optimized model parameter ⊙_{g} follows Equation (3) below. The optimization of the model parameter ⊙_{g} performed by the second trained model generation unit 22 need only be performed using a general optimization method in neural network training. The second generation unit 20 is assumed to use Og shown in the following Equation (3) as the optimized model parameter ⊙_{g}.

$$\begin{matrix}[ Math . 3 ] & \\ {Θ}_{g} = arg {max}_{{Θ}_{g}} {\prod }_{( X , {Y}^{′} , {Y}^{″} ) ϵ {D}_{g}} P ( {Y}^{″} \vert X , {Y}^{′} , {Θ}_{g} ) & ( 3 )\end{matrix}$$

Hereinafter, an example of the second trained model generation unit 22 will be described in more detail with reference to FIG. 4. FIG. 4 is a diagram illustrating an example of a configuration of the second generation unit 20. In the above-described example, the second trained model generation unit 22 generates one second trained model using a set of pieces of second training data. However, as shown in FIG. 4, in a case where the feedback comment generation unit 23 has a plurality of members, the second trained model generation unit 22 may generate a plurality of trained models corresponding to each of the plurality of members. In this case, the model parameter ⊙_{g} is expressed as ⊙_{g}={⊙_{q}, ⊙_{f}, ⊙ₛ, ⊙ₖ}.

For example, the second trained model generation unit 22 may generate a trained model for feedback comment word embedding vector calculation which is used by a feedback comment word embedding vector calculation unit 231 to calculate a feedback comment word embedding vector. The feedback comment word embedding vector is a vector in which the first semantic information indicating the meaning of one or more words in the feedback comment is embedded. The second trained model generation unit 22 generates the trained model for feedback comment word embedding vector calculation using the feedback comment and the feedback comment word embedding vector as training data for feedback comment word embedding vector calculation. A method of generating a trained model for feedback comment word embedding vector calculation is the same as the method of generating a trained model for text word embedding vector calculation, and thus the detailed description thereof will be omitted.

The second trained model generation unit 22 may generate a trained model for text and mask template word embedding vector calculation which is used by a text and mask template word embedding vector calculation unit 232 to calculate a text and mask template word embedding vector. The text and mask template word embedding vector is a vector in which information on the text word sequence embedding vector is embedded in the mask template word embedding vector. The second trained model generation unit 22 generates the trained model for text and mask template word embedding vector calculation using the text, the mask template, and the text and mask template word embedding vector as training data for text and mask template word embedding vector calculation. A method of generating a trained model for text and mask template word embedding vector calculation is the same as the method of generating a trained model for text word embedding vector calculation, and thus the detailed description thereof will be omitted.

The second trained model generation unit 22 may generate a trained model for context vector calculation which is used by a context vector calculation unit 233 to calculate a context vector. Here, the context vector is a vector in which context information indicating which word is changed in order from the first word of the feedback comment according to the text and the mask template is embedded. The second trained model generation unit 22 generates the trained model for context vector calculation using the feedback comment word embedding vector, the text and mask template word embedding vector, and the context vector as training data for context vector calculation. A method of generating a trained model for context vector calculation is the same as the method of generating a trained model for text word embedding vector calculation, and thus the detailed description thereof will be omitted.

The second trained model generation unit 22 may generate a trained model for posterior probability calculation which is used by a second posterior probability calculation unit 234 to calculate a second posterior probability. The second posterior probability is a posterior probability that a word having a feedback comment will correspond to the text, that is, a posterior probability indicating whether a word at a portion of the mask template to which a mask label is assigned is replaced with one corresponding to a word of the text. The second trained model generation unit 22 generates a second trained model for posterior probability calculation using the context vector and the second posterior probability as second training data for posterior probability calculation. A method of generating a second trained model for posterior probability calculation is the same as the method of generating a first trained model for posterior probability calculation, and thus the detailed description thereof will be omitted.

The second trained model generation unit 22 may generate a trained model for feedback comment generation which is used by the feedback comment generation unit 235 to generate a feedback comment. As an example, the second trained model generation unit 22 generates the trained model for feedback comment generation using the second posterior probability and the feedback comment as training data for feedback comment generation. A method of generating a trained model for feedback comment generation is the same as the method of generating a trained model for mask template generation, and thus the detailed description thereof will be omitted.

[1-2-3. Configuration example of feedback comment generation unit] The feedback comment generation unit 23 uses the second trained model generated by the second trained model generation unit 22 to generate a feedback comment on the basis of the text and the mask template whose input has been accepted by the second input acceptance unit 21. In this case, the feedback comment generation unit 23 inputs the text and the mask template into the second trained model, and generates a feedback comment on the basis of the output information which is output from the second trained model by probability calculation according to the model parameter ⊙_{g} of the second trained model. For example, on the basis of the output information indicating which word corresponds to the text in order from the first word of the feedback comment, that is, whether the word at the portion in the mask template to which a mask label is assigned is replaced with one corresponding to the word in the text, the feedback comment generation unit 23 generates a mask template in which the word is replaced with one corresponding to the word equivalent to this number as a feedback comment.

The feedback comment generation unit 23 may use a comment or a template selected from the comments or templates used in the second training data. The feedback comment generation unit 23 may use a comment or a template selected from the storage unit 2. A method of selecting a template is the same as the above-described method, and thus the description thereof will be omitted.

Hereinafter, an example of the feedback comment generation unit 23 will be described in detail using equations. The feedback comment generation unit 23 inputs the text and the feedback comment into the second trained model, and generates a feedback comment on the basis of the output information which is output from the second trained model by probability calculation according to the model parameters of the second trained model.

For example, the feedback comment generation unit 23 replaces the nth word yₙ″ output from the second trained model with one corresponding to the text, and generates a feedback comment Yₙ″. In this case, the feedback comment generation unit 23 uses the second trained model to obtain a second posterior probability P′(yₙ″|X, Y′, ⊙_{g}) that the nth word of the feedback comment will correspond to the text, and determines the nth word yₙ″ of the feedback comment Y″ₙ on the basis of a maximum likelihood criterion according to the following Equation (4). The details of the second posterior probability P′(yₙ″ |X, Y′, ⊙_{g}) of the mask label will be described later.

$$\begin{matrix}[ Math . 4 ] & \\ {y}_{n}^{″} = arg {max}_{{y}_{n}^{″}} P ( {y}_{n}^{″} \vert {y}_{1}^{″} , … {y}_{n - 1}^{″} , X , {Y}^{′} , {Θ}_{g} ) & ( 4 )\end{matrix}$$

The feedback comment generation unit 23 generates a word sequence Y″={y₁″, . . . , yₙ″} of the feedback comment for the text by recursively performing the above-described process. The details of the second posterior probability P′(yₙ″|X, Y′, ⊙_{g}) will be described later.

Hereinafter, an example of the feedback comment generation unit 23 will be described in more detail with reference to FIG. 4. As an example, the feedback comment generation unit 23 includes the feedback comment word embedding vector calculation unit 231, the text and mask template word embedding vector calculation unit 232, the context vector calculation unit 233, the second posterior probability calculation unit 234, and the feedback comment generation unit 235.

The feedback comment word embedding vector calculation unit 231 calculates the feedback comment word embedding vector using the trained model for feedback comment word embedding vector calculation generated by the second trained model generation unit 22. For example, the feedback comment word embedding vector calculation unit 231 inputs the word sequence Y″={y₁″, . . . , yₙ₋₁″} from the first to (n−1)th words of the feedback comment into the trained model for feedback comment word embedding vector calculation, and calculates the output information which is output from the trained model for feedback comment word embedding vector calculation as a word embedding vector pₙ of the feedback comment. As an example, the feedback comment word embedding vector calculation unit 231 calculates the converted word sequence Y″ from the first to (n−1)th words of the feedback comment as the word embedding vector pₙ of the feedback comment using a conversion function based on the optimized model parameter ⊙_{f} of the trained model for feedback comment word embedding vector calculation. A method of calculating a feedback comment word embedding vector is the same as the method of calculating a text word embedding vector, and thus the detailed description thereof will be omitted.

The text and mask template word embedding vector calculation unit 232 calculates the text and mask template word embedding vector using the trained model for text and mask template word embedding vector calculation generated by the second trained model generation unit 22. For example, the text and mask template word embedding vector calculation unit 232 inputs the text word sequence X and the mask template word sequence Y′={y₁′, . . . , yₖ′} into the trained model for text and mask template word embedding vector calculation, and calculates the output information which is output from the trained model for text and mask template word embedding vector calculation as a text and mask template word embedding vector qₖ. As an example, the text and mask template word embedding vector calculation unit 232 calculates the converted text word sequence X and mask template word sequence Y′={y₁′, . . . , yₖ′} as the text and mask template word embedding vector qₖ using a conversion function based on the optimized model parameter ⊙_{q} of the trained model for text and mask template word embedding vector calculation. A method of calculating a text and mask template word embedding vector is the same as the method of calculating a text word embedding vector, and thus the detailed description thereof will be omitted.

The context vector calculation unit 233 calculates a context vector using the trained model for context vector calculation generated by the second trained model generation unit 22. For example, the context vector calculation unit 233 inputs the feedback comment word embedding vector pₙ calculated by the feedback comment word embedding vector calculation unit 231 and the text and mask template word embedding vector sequence Q={q₁, . . . , qₖ} calculated by the text and mask template word embedding vector calculation unit 232 into the trained model for context vector calculation, and calculates the output information which is output from the trained model for context vector calculation as a context vector sₙ. As an example, the context vector calculation unit 233 calculates the converted feedback comment word embedding vector pₙ and text and mask template word embedding vector sequence Q as the context vector sₙ using a conversion function based on the optimized model parameter ⊙ₛ of the trained model for context vector calculation.

In this case, any conversion function can be used insofar as the conversion function is a function of converting two types of variable-length vectors into a single vector. Examples of the conversion function include a function of expressing the feedback comment word embedding vector and the text and mask template word embedding vector sequence as a single context vector by adding an attention mechanism, and the like.

The second posterior probability calculation unit 234 calculates the second posterior probability using the second trained model for posterior probability calculation generated by the second trained model generation unit 22. For example, the second posterior probability calculation unit 234 inputs the context vector sₙ calculated by the context vector calculation unit 233 into the second trained model for posterior probability calculation, and calculates the output information which is output from the second trained model for posterior probability calculation as the second posterior probability P′(yₙ″|X, Y′, ⊙_{g}) that the nth word of the feedback comment for the text corresponds to the text. As an example, the second posterior probability calculation unit 234 calculates the converted context vector sₙ as the second posterior probability P′(yₙ″|X, Y′, ⊙_{g}) that the nth word of the feedback comment for the text corresponds to the text using a conversion function based on the optimized model parameter Ox of the second trained model for posterior probability calculation. A method of calculating a second posterior probability is the same as the method of calculating a first posterior probability, and thus the detailed description thereof will be omitted.

The feedback comment generation unit 235 generates a feedback comment using the trained model for feedback comment generation generated by the second trained model generation unit 22. For example, the feedback comment generation unit 235 inputs the second posterior probability P′(y₁″|X, Y′, ⊙_{g}), . . . , P′(yₙ″|y₁′, . . . yₙ₋₁′, X, Y′, ⊙_{g}) for the first to nth words of the feedback comment calculated by the second posterior probability calculation unit 234 into the trained model for feedback comment generation, and calculates the output information which is output from the trained model for feedback comment generation as the feedback comment word sequence Y″.

In this case, the feedback comment generation unit 235 selects the maximum second posterior probability P′(y₁″|X, Y′, ⊙_{g}), . . . , P′(yₙ″|y₁′, . . . , yₙ₋₁′, X, Y′, ⊙_{g}) for the first to nth words of the feedback comment. As an example, the feedback comment generation unit 235 converts the second posterior probability P′(yₙ″|y₁′, . . . yₙ₋₁′, X, Y′, ⊙_{g}) corresponding to the nth word of the feedback comment into the word sequence Y″ of the feedback comment.

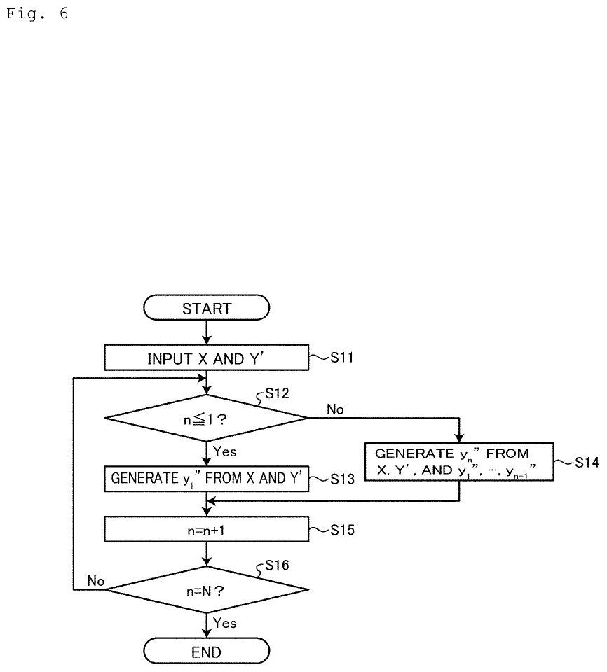

As a method of selecting an element in the second posterior probability P′(yₙ″|y₁′, . . . yₙ₋₁′, X, Y′, ⊙_{g}), any method of maximizing the second posterior probability can be used, for example, an approximation algorithm such as a greedy method. The feedback comment generation unit 235 repeats the above-described process until all words in the feedback comment are generated. The details of the flow of a feedback comment generation process will be described later with reference to FIG. 6. In addition, in the above-described example, the feedback comment generation unit 235 generates all words in the feedback comment, but may predict only the words in the masked portion to which a mask label is assigned and which is replaced with a mask token. In this case, the feedback comment generation unit 235 performs a process of generating only words equivalent to the masked portion, and does not need to repeat the above-described process until all words are generated. In this case, as in the above-described example, the effect of making it difficult for excessive changes to occur to the template can be obtained.

### [2. Flow of Processing Performed by Learning Device]

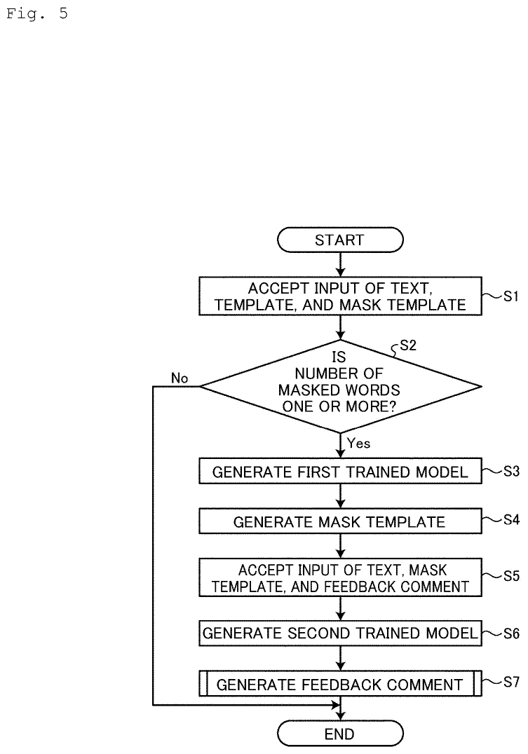

Hereinafter, the flow of processing performed by the learning device 1 will be described with reference to FIG. 5. FIG. 5 is a flowchart illustrating an example of a flow of processing performed by the learning device 1.

As shown in FIG. 5, the first input acceptance unit 11 of the learning device 1 accepts input of text, a template of a feedback comment for the text, and a mask template in which zero or one or more words of the template are masked (step S1).

For the mask template, in a case where the number of masked word in the template is one or more (Yes in step S2), the first trained model generation unit 12 of the learning device 1 uses the text, template, and mask template whose input has been accepted by the first input acceptance unit 11 as the first training data to generate the first trained model that outputs a mask template in a case where the text and the template are input (step S3). For the mask template, in a case where the number of masked words in the template is not one or more (No in step S2), the learning device 1 ends the process. Specifically, in a case where the number of masked words in the template is 0, that is, a case where all words in the template are not masked, the learning device 1 does not generate a feedback comment through the second generation unit 20, and outputs the template in which none of the words are masked as it is as a feedback comment.

The mask template generation unit 13 of the learning device 1 generates a mask template using the first trained model generated by the first trained model generation unit 12 (step S4).

The second input acceptance unit 21 of the learning device 1 accepts input of the text, the mask template, and the feedback comment in which the masked portion of the mask template has been changed (step S5).

The second trained model generation unit 22 of the learning device 1 uses the text, the mask template, and the feedback comment whose input has been accepted by the second input acceptance unit 21 as the second training data to generate the second trained model that outputs a feedback comment in a case where the text and the mask template are input (step S6).

The feedback comment generation unit 23 of the learning device 1 generates a feedback comment using the second trained model generated by the second trained model generation unit 22 (step S7).

In the above-described example, the learning device 1 generates the first trained model through the first trained model generation unit 12, and then generates the second trained model through the second trained model generation unit 22. However, the order in which the first trained model and the second trained model are generated by the learning device 1 is not particularly limited. For example, the learning device 1 may generate the first trained model through the first trained model generation unit 12 and generate the second trained model through the second trained model generation unit 22 in parallel. In addition, the learning device 1 may generate the second trained model through the second trained model generation unit 22, and then generate the first trained model through the first trained model generation unit 12.

Next, an example of the flow of the feedback comment generation process performed by the learning device 1 in step S7 of FIG. 5 described above will be described in detail with reference to FIG. 6. FIG. 6 is a flowchart illustrating an example of a flow of the feedback comment generation process performed by the learning device 1.

As shown in FIG. 6, the feedback comment generation unit 23 of the learning device 1 inputs the word sequence X of the text and the word sequence Y′ of the mask template into the second trained model (step S11).

If the word number when counting in order from the first word of the feedback comment is 1 or less, that is, if n≤1 (Yes in step S12), the feedback comment generation unit 23 uses the second trained model to generate the first word y″ of the feedback comment (step S13).

If n>1 (No in step S12), the feedback comment generation unit 23 uses the second trained model to generate the nth word yₙ″ of the feedback comment from the word sequence X of the text, the word sequence Y′ of the mask template, and the word sequence Y″={y₁″, . . . , yₙ₋₁″} from the first to (n−1)th words of the feedback comment (step S14).

After the nth word of the feedback comment is generated, the feedback comment generation unit 23 substitutes n+1 for n (step S15).

The feedback comment generation unit 23 determines whether the number n of the word in the feedback comment is equal to the number N of the last word in the feedback comment. If n=N (Yes in step S16), the feedback comment generation unit 23 ends the process. If n=N is not true (No in step S16), that is, if n/N, the feedback comment generation unit 23 returns to step S12 and repeats the above-described process.

[3. Effects] The learning device 1 according to the present embodiment includes a first input acceptance unit 11 configured to accept input of text, a template of a feedback comment for the text, and a mask template in which zero or one or more words of the template are masked, and a first trained model generation unit 12 configured to generate a first trained model that outputs the mask template in a case where the text and the template are input using the text, the template, and the mask template whose input has been accepted by the first input acceptance unit 11 as first training data.

In a case where the text and the template are input, the learning device 1 generates the first trained model that outputs the mask template in which only zero or one or more words to be changed are masked in an already existing template. Therefore, the learning device 1 can generate the first trained model that outputs the mask template corresponding to the text in which only a part of the template has been changed. In addition, the learning device 1 generates the first trained model using the template corresponding to already existing text as the first training data, and thus can prevent a mask template unrelated to the text from being output from the first trained model. This enables the learning device 1 to generate a mask template for generating feedback text in which only the masked portion has been changed, which makes it less likely that excessive changes to the template will occur, such as changing even the portion of the template corresponding to the text.

In addition, the learning device 1 can generate the first trained model that outputs the mask template in which a portion where zero or one or more words are changed is predicted as a masked portion. Therefore, even if the template is completely unrelated to the text, the learning device 1 can generate the first trained model that outputs a mask template represented only by the masked portion. Thus, in a case where the template corresponds to the text, the learning device 1 can generate the first trained model that outputs a mask template in which the template is utilized and only the portion that does not correspond to the text is masked. In addition, even in a case where the template does not correspond to the text at all, the learning device 1 can flexibly respond to this case and generate the first trained model that outputs a mask template represented only by the masked portion.

The learning device 1 according to the present embodiment further includes a second input acceptance unit 21 configured to accept input of the text, the mask template, and a feedback comment in which a masked portion of the mask template is changed, and a second trained model generation unit 22 configured to generate a second trained model that outputs the feedback comment in a case where the text and the mask template are input using the text, the mask template, and the feedback comment whose input has been accepted by the second input acceptance unit 21 as second training data.

In a case where the text and the mask template are input, the learning device 1 generates the second trained model that outputs the feedback comment in which the masked portion of the mask template is changed. This enables the learning device 1 to generate the second trained model that outputs the feedback comment corresponding to the text in which only the masked portion of the mask template has been changed, which makes it less likely that excessive changes to the template will occur.

In the learning device 1 according to the present embodiment, the second trained model generation unit 22 trains the second trained model using the feedback comment output from the second trained model as the second training data. This enables the learning device 1 to recursively train the second trained model using the feedback comment in which the learning result of the second trained model is reflected as the second training data. As a result, the learning device 1 can generate the second trained model that outputs the feedback comment which is more responsive to the comment.

In the learning device 1 according to the present embodiment, the second trained model generation unit 22 generates the second trained model using the mask template, excluding words in the masked portion and including only words of the feedback comment, as the second training data. This allows the learning device 1 to generate the second trained model using the mask template, excluding words in the masked portion and close to the feedback comment corresponding to the comment, as the second training data. As a result, the learning device 1 can generate the second trained model that outputs the feedback comment in which the words in the masked portion of the mask template are replaced with words corresponding to the comment.

In the learning device 1 according to the present embodiment, the first trained model generation unit 12 generates the first trained model using the first training data in which at least one of the text and the template includes at least one of the first semantic information indicating the meaning of one or more words and the second semantic information indicating the meaning of the entire sentence. In addition, the second trained model generation unit 22 generates the second trained model using the second training data in which at least one of the text and the feedback comment includes at least one of the first semantic information and the second semantic information. This makes it possible for the learning device 1 to generate the first trained model that outputs a mask template close to the meaning expressed by the input text and template, and to generate the second trained model that outputs a feedback comment close to the meaning expressed by the input text.

In the learning device 1 according to the present embodiment, the second trained model generation unit 22 generates the second trained model using the second training data in which the feedback comment includes context information indicating which word is changed in order from the first word of the feedback comment according to the text and the mask template. This makes it possible for the learning device 1 to generate the second trained model that outputs a feedback comment in which words in an appropriate portion among the masked portions of the mask template have been changed.

[4. Program] It is also possible to create a program in which the processing executed by the learning device 1 according to the above-described embodiment is written in a language executable by a computer. In this case, by the computer executing the program, it is possible to obtain the same effects as in the above-described embodiment. Further, such a program may be recorded in a computer readable recording medium, and the program recorded in this recording medium may be read by the computer and executed to realize the same processing as in the above-described embodiment.

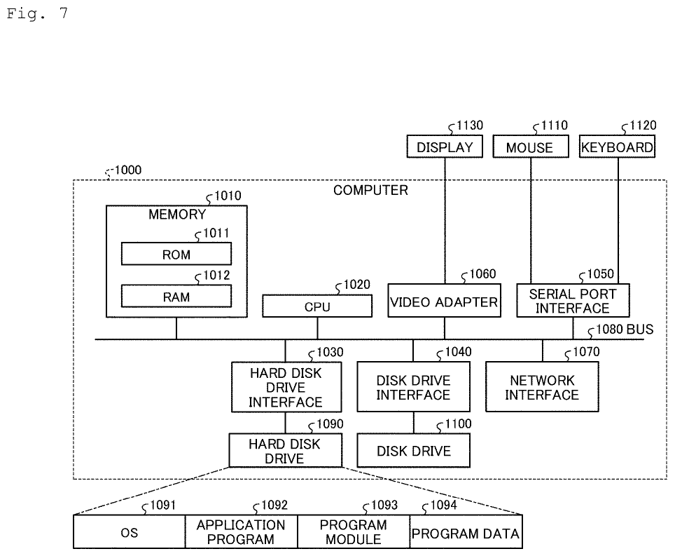

FIG. 7 is a diagram illustrating an example of a computer that executes a learning program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 has a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. A detachable storage medium such as, for example, a magnetic disc or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program that defines each process of the learning device 1 is implemented as the program module 1093 in which codes executable by the computer are described. The program module 1093 is stored in, for example, the hard disk drive 1090. For example, the program module 1093 for executing the same processing as in the functional configuration of the learning device 1 is stored in the hard disk drive 1090. The hard disk drive 1090 may be replaced with a solid state drive (SSD).

In addition, the setting data used in the processing of the above-described embodiment is stored as the program data 1094 in, for example, the memory 1010 or the hard disk drive 1090. The CPU 1020 reads out the program module 1093 or the program data 1094 stored in the memory 1010 or the hard disk drive 1090 into the RAM 1012 as necessary, and executes the processing of the above-described embodiment.

The program module 1093 and the program data 1094 are not limited to being stored in the hard disk drive 1090, and may be stored in, for example, a detachable storage medium and read by the CPU 1020 through the disk drive 1100 or the like. Alternatively, the program module 1093 and the program data 1094 may be stored in another computer connected through a network (a local area network (LAN), a wide area network (WAN), or the like). The program module 1093 and the program data 1094 may be read out from another computer through the network interface 1070 by the CPU 1020.

[5. Supplementary note] The following supplements will be further disclosed regarding the above embodiments.

### Supplement 1

The learning device comprising:
a memory; and
at least one processor connected to the memory, wherein the processor
accepts input of text, a template of a feedback comment for the text, and a mask template in which zero or one or more words of the template are masked, and
generates a first trained model that outputs the mask template in a case where the text and the template are input using the text, the template, and the mask template whose input has been accepted as first training data.

### Supplement 2

A non-transitory storage medium storing a program executable by a computer to execute a learning process performed by the learning device according to supplement 1.

### REFERENCE SIGNS LIST

1 Learning device
11 First input acceptance unit
12 First trained model generation unit
21 Second input acceptance unit
22 Second trained model generation unit

1. A learning device comprising:
a memory; and
processing circuitry configured to:
accept input of text, a template of a feedback comment for the text, and a mask template in which zero or one or more words of the template are masked; and
generate a first trained model that outputs the mask template in a case where the text and the template are input using the text, the template, and the mask template whose input has been accepted as first training data.

2. The learning device according to claim 1, wherein the processing circuitry is further configured to:
accept input of the text, the mask template, and a feedback comment in which a masked portion of the mask template is changed, and
generate a second trained model that outputs the feedback comment in a case where the text and the mask template are input using the text, the mask template, and the feedback comment whose input has been accepted as second training data.

3. The learning device according to claim 2, wherein the processing circuitry is further configured to train the second trained model using the feedback comment output from the second trained model as the second training data.

4. The learning device according to claim 3, wherein the processing circuitry is further configured to generate the second trained model using the mask template, excluding words in the masked portion and including only words of the feedback comment, as the second training data.

5. The learning device according to claim 4, wherein the processing circuitry is further configured to:
generate the first trained model using the first training data in which at least one of the text and the template includes at least one of first semantic information indicating a meaning of the one or more words and second semantic information indicating a meaning of an entire sentence, and
generate the second trained model using the second training data in which at least one of the text and the feedback comment includes at least one of the first semantic information and the second semantic information.

6. The learning device according to claim 2, wherein the processing circuitry is further configured to generate the second trained model using the second training data in which the feedback comment includes context information indicating which word is changed in order from a first word of the feedback comment according to the text and the mask template.

7. A learning method executed by a learning device, comprising:
accepting input of text, a template of a feedback comment for the text, and a mask template in which zero or one or more words of the template are masked; and
generating a first trained model that outputs the mask template in a case where the text and the template are input using the text, the template, and the mask template whose input has been accepted as first training data.

8. A non-transitory computer-readable recording medium storing therein a learning program that causes a computer to execute a process comprising:
accepting input of text, a template of a feedback comment for the text, and a mask template in which zero or one or more words of the template are masked; and
generating a first trained model that outputs the mask template in a case where the text and the template are input using the text, the template, and the mask template whose input has been accepted as first training data.
